(19) United States
(12) Patent Application Publication
(10) Pub. No.: US 2026/0100032 A1
(43) Pub. Date: Apr. 9, 2026

(54) Method, Control Programme, Computer-Readable Data Carrier And Image Processing Unit For Providing An Image Dataset And Apparatus With Same

(71) Applicant: Airbus Defence and Space GmbH, Taufkirchen (DE)

(72) Inventor: Leonhard Vogelmeier, Taufkirchen (DE)

(73) Assignee: Airbus Defence and Space GmbH, Taufkirchen (DE)

(21) Appl. No.: 19/234,622

(22) Filed: Jun. 11, 2025

(30) Foreign Application Priority Data
Jun. 14, 2024 (DE) 102024116831.5

(51) Int. Cl. G06V 20/17; G06T 7/20

(52) U.S. Cl. CPC G06V 20/17; G06T 7/20; G06T 2207/30241

(57) ABSTRACT

A method for providing an image data set from an image processing unit of an apparatus, such as an aircraft, to at least one display device for operators (P) of the apparatus, a control program, a computer-readable data carrier, an image processing unit for an apparatus, in particular an aircraft, are proposed, wherein the image data set includes at least two levels of detail of at least one image element obtained from a sensor module, a database module and/or a receiving module.

### TECHNICAL FIELD

The present disclosure relates to a method for providing an image data set from an image processing unit of an apparatus, such as an aircraft, to at least one display device for operators of the apparatus, to a control program, to a computer-readable data carrier, to an image processing unit for an apparatus, and to an apparatus, in particular an aircraft.

### TECHNICAL BACKGROUND

Methods for controlling a data transmission of egocentric or exocentric image data sets are known from the prior art. Egocentric image data sets are usually transmitted to head-mounted display devices, such as so-called head-mounted displays (HMD), which are worn by an operator of an apparatus, such as a pilot, attached to his head. Such display devices can be integrated, for example, in visors of helmets, or the like. They serve to provide the operator with relevant information from his own perspective. On the other hand, apparatus-mounted display devices in the form of screens integrated in a housing or a driver's cab, for example a cockpit, can serve to provide the operator with overview representations, such as map and navigation material, as well as instrument panels or operating data of the apparatus.

EP 3 983 870 B1, for example, relates to a system for mission preparation on the basis of digital mapping, which comprises a mission editor that generates mission elements that vary during a multiplicity of predetermined time phases and which, in a network, comprises: —a mission server, —a mapping server, —a server for sharing at least one map center point, and—a multiplicity of augmented reality headsets, wherein at least one of the augmented reality headsets, referred to as the master headset, can generate at least one instruction to change the center point, wherein each headset can receive at least two sets of elevation and terrain tiles from the mapping server, wherein the mission server communicates with the headsets in order to share and update the mission elements and to allow them to be varied over time.

U.S. Pat. No. 10,204,453 B2 describes an aviator mask that includes an augmented reality visor, sensors and a display computing unit. The sensors are communicatively connected to the augmented reality visor. The sensors detect a portion of the cockpit area of an aircraft that can be viewed by a crew member with the augmented reality visor during an emergency with restricted vision. The display computing unit is communicatively connected to the augmented reality visor and the sensors. The display computing unit projects a pre-stored image that is assigned to the portion of the cockpit area in front of the augmented reality visor. In addition, the display computing unit overlays the pre-stored image over that portion of the cockpit area which is seen by the crew member of the aircraft. The overlaid, pre-stored image is viewed by the crew member of the aircraft through the augmented reality visor in order to identify objects in the cockpit area during the emergency with obscured vision.

EP 3 100 768 A1 relates to an aviator mask comprising a first set of sensors that monitor the ambient air in the cockpit and the health status of a crew member in order to identify parameters causing breathing difficulties for the crew member, an oxygen regulator that switches between a dilution mode, an emergency mode and a recirculation mode in order to supply respiratory gas to the crew member.

U.S. Pat. No. 9,950,806 B2 deals with a method for displaying an outside scene on a cockpit display system. The system comprises two display areas adjacent to each other along a horizontal aircraft axis, and a processor that generates, in one of the areas, the display of an initial scene image from data from the aircraft's avionics electronics, the data comprising the aircraft's sideslip angle. The processor displays, on the scene image, a flight path vector indicating a point on the scene image toward which the aircraft is heading. When the measured sideslip angle exceeds a threshold value, the processor displays the original scene image in a first display area and displays a supplementary outside scene image in a second display area, with the supplementary scene image representing a lateral extension of the original scene image. The processor also displays the flight path vector which is overlaid on one of the two images based on an angle value.

U.S. Pat. No. 8,416,151 B2 relates to a set of items of equipment for an aircraft, comprising a video converter and at least two head-up display devices, the video converter and/or each HUD device being able to define the image to be projected by the HUD device based on the display field of the HUD device and one or more HUD/converter errors, each HUD/converter error being defined as the difference between the HUD error of the corresponding HUD wearer around one direction and the converter error around that same direction, wherein the HUD error of a HUD wearer around one direction is the angular difference around that direction between the line of sight of the HUD wearer and a measurement reference line, and wherein the converter error around one direction is the angular difference around that direction between the line of sight of the converter carrier and a measurement reference line.

In methods and systems known from the prior art for data transmission to display devices, it is disadvantageous that they relate only to a partial aspect of the operation of an apparatus, such as an aircraft. However, especially in the operation of aircraft, it can be expected in the future that ranges of tasks of individual operators, such as pilots, will significantly expand. For example, an expansion can result from the fact that, in addition to controlling their own aircraft in close combat situations, fighter pilots will also have to control remote-controlled Unmanned Air Vehicles (UAV) from a relatively long distance from the action.

In such multifaceted ranges of tasks, the problem is that, on one side of the spectrum of views to be provided, egocentric perspectives and the view of a real world outside the cockpit with the human eye can be the priority in certain situations. On the other side of the spectrum, an exocentric view of a synthetic environment that is provided with the aid of sensors may have to be dominant in certain situations. A challenge for a pilot is then to quickly switch his perception between said two sides of the spectrum against the backdrop of the unpredictability of the action.

### DESCRIPTION

It can be regarded as an object to improve a preparation of data streams comprising image data sets on display devices for uninterrupted perceptibility by operators of apparatuses. In particular, it can be regarded as an object to simplify the handling of a switch between situation-dependent information spectra and/or perspectives for operators and to make them as comprehensible as possible. It can also be regarded as an object to increase a situation awareness when operating apparatuses, in particular aircraft, or at least maintain it to such an extent that it is not lost if possible, even under highly complex conditions.

This object is achieved by the subject matter of independent claim 1 and also of coordinate claims 7 to 10. Further embodiments emerge from the dependent claims and from the following description.

In particular, the object is achieved by a method for providing an image data set from an image processing unit of an apparatus, such as an aircraft, to at least one display device for operators of the apparatus, wherein the image data set comprises at least two levels of detail of at least one image element obtained from a sensor module, a database module and/or a receiving module.

In the case of a control program, the object is achieved by virtue of the fact that it comprises instructions which, when the control program is executed by an image processing unit, cause the latter to carry out a corresponding method.

In the case of a readable data carrier, the object is achieved by storing a corresponding control program on the data carrier.

In the case of an image processing unit for an apparatus, such as an aircraft, this object is achieved by virtue of the fact that the image processing unit is configured to carry out a corresponding method and/or comprises a corresponding computer-readable data carrier.

In the case of an apparatus, in particular an aircraft, this object is achieved by virtue of the fact that the apparatus comprises a corresponding image processing unit.

At least two levels of detail of an image element can thus be reproduced simultaneously with the display device. Various sections of the image data set, such as image sections, can be provided with a selectable level of detail. Degrees of detail of the levels of detail can be designed to be permanently delimitable from each other.

The sensor module, database module and/or receiving module can be part of the image processing unit and/or connected to the latter in a data-transmitting manner. For example, the sensor module can access sensor arrangements, such as a camera, a locating device, an infrared vision device, a night vision device, a radar device or the like, which may be provided as part of the aircraft or as devices connected to the latter in a data-transmitting manner. Appropriate data capture arrangements may be provided for this purpose. Different apparatuses can exchange appropriate data with each other via a network.

The solution according to the invention has the advantage that the operator, for example a pilot of an aircraft, can be provided with exactly the image elements needed at the respective time, nothing more, nothing less, in a cognitive processable manner. The solution therefore makes an ever-increasing number of data sets and corresponding information, as can occur in combat situations for example, processable for the operator. In addition, the speed of perception, overview and orientation are improved in every situation in order to be able to make decisions as quickly and accurately as possible.

According to one embodiment of the method, it may be provided that the at least one image element is part of a data subset which is obtained from a data memory, from the sensor module and/or by remote data transmission. The data subset can be part of a sensor data set captured by the sensor module or a sensor connected to it. The data subset can represent a specific image element and/or an image section, such as a map section. Thus, image elements can be handled in a manner combined into groups, subgroups, image data sets and/or data subsets, which helps to simplify their cognitively processable provision.

According to one embodiment of the method, it may be provided that the at least one image element in at least one of the at least two levels of detail is abstracted to form a symbol representation. A degree of abstraction of the symbol representation can be selected by the operator. This helps to increase the flexibility of the information processing and to adapt it to the respective needs of the operator.

According to one embodiment of the method, it may be provided that at least one of the at least two levels of detail is at least partially superimposed on at least one other of the at least two levels of detail. The levels of detail can be overlaid. This helps to process provided image data sets or their data subsets according to respective requirements in such a way that they are presented in a processable manner for the operator and at the same time contain all the necessary information as far as possible.

According to one embodiment of the method, it may be provided that the at least two levels of detail are incremented in a predefined manner. In other words, the levels of detail and/or correspondingly used symbol representations can be converted in stages into each other according to predefined limits or switched between each other. This helps to simplify the selection of the levels of detail for an operator by means of appropriate control signals and to avoid unnecessary complexity in operation.

According to one embodiment of the method, it may be provided that objects, object groups and/or their routes or trajectories captured by the sensor module are provided in at least one of the at least two levels of detail as a single and/or combined image element. Objects can be combined in groups. The objects and their groups can be assigned to different levels of detail. This makes it possible to generate object clouds, for example. In the case of known objects, such as own or allied forces, the assignment to a particular group can be made directly by means of appropriate data exchange, in particular via a guidance system. Unknown objects, such as enemy forces, can first be classified as unknown and then identified and/or grouped accordingly by manual marking and/or machine learning algorithms or artificial intelligence. This also helps to process provided image data sets or their data subsets according to respective requirements in such a way that they are presented in a processable manner for the operator and at the same time contain all the necessary information as far as possible.

Alternatively, or additionally, the object is achieved by a method for controlling a data transmission of an egocentric image data set and an exocentric image data set from an image processing unit of an apparatus, such as an aircraft, to at least one head-mounted display device and at least one apparatus-mounted display device for operators of the apparatus, wherein, by way of a control signal that can be triggered by the operator, at least one data subset from the egocentric image data set can be optionally sent to the apparatus-mounted display device and/or at least one data subset from the exocentric image data set can be optionally sent to the head-mounted display device.

Image data sets or corresponding image elements for both egocentric and exocentric views can thus be optionally sent to the head-mounted and/or the apparatus-mounted display device. An operating unit that can be controlled as intuitively as possible by the operator can capture the control signal and send it to the image processing unit. The operator can thus switch between egocentric and exocentric representations according to respective requirements, for example by optionally allowing them to be transmitted from the image processing unit to the head-mounted display device and/or the apparatus-mounted display device. The data subsets can each reproduce predetermined views or sections thereof and can be at least partially complementary and/or redundant to each other, for example by reproducing different views of an identical object and/or environment field. Image data sets and/or data subsets can be composed and/or generated by the image processing unit and can comprise, for example, map representations and elements displayed therein.

This solution has the advantage that it is possible to provide a completely novel concept of a human machine interface which can be adapted to respective requirements of relatively wide and multifaceted ranges of tasks. In particular, the operator can be provided with cognitively comprehensible transitions between situation-dependent information spectra and/or perspectives. The information content provided can be adapted according to the respective requirements. This makes it possible to avoid cognitive interruptions which could reduce performance, impair assessments and/or cause errors.

According to one embodiment of the method, it may be provided that at least one image element from at least one of the data subsets is obtained from a sensor module. A sensor module, database module and/or receiving module can be part of the image processing unit and/or connected to the latter in a data-transmitting manner. For example, the sensor module can access sensor arrangements, such as a camera, a locating device, an infrared vision device, a night vision device, a radar device or the like, which may be provided as part of the aircraft or as devices connected to the latter in a data-transmitting manner. Appropriate data capture arrangements may be provided for this purpose. Different apparatuses can exchange appropriate data with each other via a network. This makes it possible to synthetically compose and provide image data sets or their data subsets according to the respective requirements.

According to one embodiment of the method, it may be provided that the at least one image element is abstracted to form a symbol representation which is simultaneously contained in the egocentric image data set and in the exocentric image data set. A degree of abstraction of the symbol representation can be infinitely adjustable. The egocentric and/or exocentric data set can be formed from fully abstracted symbol representations. This means that a large amount of information content from or in different reference systems can be processed so as to be able to be cognitively perceived by the operator without interruption.

According to one embodiment of the method, it may be provided that a data subset sent to the head-mounted display device is at least partially superimposed on a data subset sent to the apparatus-mounted display device. The head-mounted display device can be superimposed on the apparatus-mounted display device to any degree, up to complete superimposition. In other words, the head-mounted display device can hide the apparatus-mounted display device. Alternatively, or additionally, the data subsets can be complementary to each other in such a way that the apparatus-side display device appears to be at least partially punched out from the data subset sent to the head-mounted display device. In other words, at least in the eyes of the operator, the data subset sent to the apparatus-mounted display device may appear to be integrated in the data subset sent to the head-mounted display device. This makes it possible to further improve processing of a large amount of information content from or in different reference systems that can be cognitively perceived by the operator without interruption, in particular by being able to fully exploit a field of view of the operator and being able to send image data sets or their data subsets arranged therein to a head-mounted and/or apparatus-mounted display device with constant reference to each other according to respective requirements.

According to one embodiment of the method, it may be provided that data subsets from the egocentric image data set and/or from the exocentric image data set that are sent to the head-mounted display device and/or to the apparatus-mounted display device are continuously superimposed or there is substantially continuous switching between them for the operator. In other words, egocentric image data sets can transition into exocentric image data sets and vice versa. Thus, the orientation in the views can be simplified for an operator, in particular when changing from exocentric to egocentric views, or it is possible to prevent the operator from losing orientation.

According to one embodiment of the method, it may be provided that a data subset from the egocentric image data set and/or a data subset from the exocentric image data set is/are assigned to at least two different operating zones of the apparatus and, depending on the operating zone predefined to the image processing unit, can be sent to the head-mounted display device and/or the apparatus-mounted display device. The operating zones can be assigned to respective risk levels for the operation of the apparatus. Thus, different aspects relevant to the operator from the egocentric and/or exocentric image data set can be respectively sent to the head-mounted display device and/or the apparatus-mounted display device in respective operating zones with different risk levels.

### BRIEF DESCRIPTION OF THE FIGURES

A more specific description of some details is given below with reference to the accompanying drawings. The illustrations are schematic and not true to scale. Identical reference signs refer to identical or similar elements. In the drawings:

FIG. 1 shows a schematic illustration of an apparatus with an image processing unit;

FIG. 2 shows a schematic illustration of operating zones for operating the apparatus;

FIG. 3 shows a schematic illustration of an exemplary assignment of image data sets to a head-mounted display device and an apparatus-mounted display device on the basis of the operating zones;

FIG. 4 shows a schematic illustration of an exemplary assignment of image data sets to the head-mounted display device and the apparatus-mounted display device according to the third operating zone;

FIG. 5 shows a further schematic illustration of an exemplary assignment of image data sets to the head-mounted display device and the apparatus-mounted display device according to the third operating zone;

FIG. 6 shows an additional schematic illustration of an exemplary assignment of image data sets to the head-mounted display device and the apparatus-mounted display device according to the third operating zone;

FIG. 7 shows a schematic illustration of an exemplary assignment of image data sets to the head-mounted display device and the apparatus-mounted display device according to the second operating zone;

FIG. 8 shows a schematic illustration of an exemplary assignment of image data sets to the head-mounted display device and the apparatus-mounted display device according to the first operating zone;

FIG. 9 shows a schematic illustration of an image data set with image elements in a plurality of levels of detail;

FIG. 10 shows a schematic illustration of an image data set with image elements in a plurality of overlaid levels of detail;

FIG. 11 shows a schematic illustration of an image data set with data subsets in a plurality of levels of detail;

FIG. 12 shows a schematic symbol representation of an object;

FIG. 13 shows a schematic symbol representation of object groups;

FIG. 14 shows a further schematic symbol representation of object groups;

FIG. 15 shows a further symbol representation of an object;

FIG. 16 shows a schematic symbol representation of an object for an object group;

FIG. 17 shows a schematic symbol representation of an object group with symbol representations of objects shown in FIG. 16;

FIG. 18 shows a schematic symbol representation of an object group;

FIG. 19 shows a further schematic symbol representation of the object group shown in FIG. 18;

FIG. 20 shows an additional schematic symbol representation of the object group shown in FIGS. 18 to 19;

FIG. 21 shows an alternative schematic symbol representation of the object group shown in FIGS. 18 to 20;

FIG. 22 shows a further alternative schematic symbol representation of the object group shown in FIGS. 18 to 21;

FIG. 23 shows an additional alternative schematic symbol representation of the object group shown in FIGS. 18 to 22;

FIG. 24 shows a schematic illustration of construction elements for generating a symbol representation of the object group shown in FIGS. 18 to 23;

FIG. 25 shows a schematic symbol representation of the object group shown in FIGS. 18 to 23 after using the construction elements shown in FIG. 24.

### DETAILED DESCRIPTION

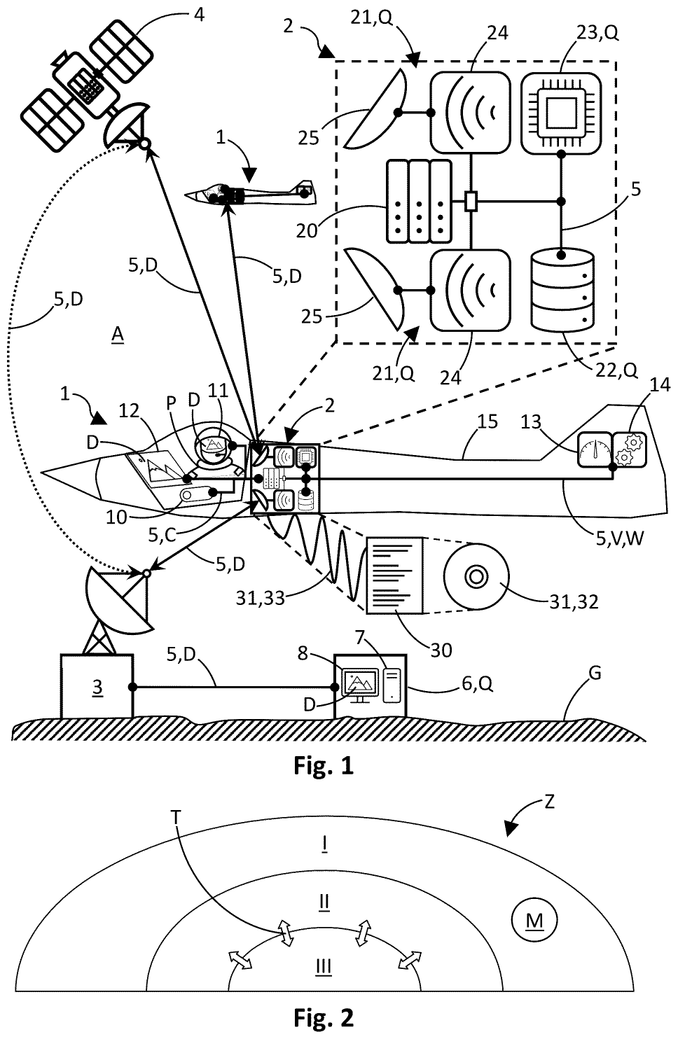

FIG. 1 shows a schematic illustration of an apparatus 1 in the form of an aircraft with an image processing unit 2 which may be configured to communicate with various further devices, such as a further apparatus 1 in the form of a further aircraft, for example a UAV, a ground station 3 and/or a satellite 4, which can be used by the image processing unit 2 as data sources Q for an image data set D and are arranged on the ground G and/or in the air A or in space. The apparatuses 1, ground stations 3 and/or satellites 4 may be connected to each other and to further data sources Q, such as data centers 6 with data processing systems 7 and their display devices 8, in a wired and/or wireless manner via communication infrastructures 5. Operators P, such as a pilot of an aircraft, can operate the apparatuses 1, ground stations 3 and/or satellites 4.

The apparatus 1 comprises at least one operating arrangement 10, at least one head-mounted display device 11 and at least one apparatus-mounted display device 12. With the aid of the operating arrangement 10, the operator P can generate or output control signals C for controlling the apparatus 1 and/or the image processing unit 2. For this purpose, the operating arrangement 10 may comprise corresponding control elements, such as virtual and/or physical switches, sliders, controllers, knobs, wheels, pointers or the like, which can provide binary, incremental and/or stepless control signals C. The head-mounted display device 11 can be provided as an HMD, for example. The apparatus-mounted display device can be provided as a large area display (LAD), for example.

Furthermore, the apparatus 1 may comprise sensor elements 13 and/or actuators 14 which may provide sensor signals V or manipulated values W, such as actual and/or target values. All components of the apparatus 1 and the operator P may be held, attached and/or accommodated on or in an apparatus structure 15, such as an aircraft fuselage including a cockpit or the like. The at least one operating arrangement 10, at least one head-mounted display device 11 and/or at least one apparatus-mounted display device 12 can again be connected to each other and to further data sources Q, such as data centers 6 with data processing systems 7 and their display devices 8, in a wired and/or wireless manner via communication infrastructures 5.

The image processing unit 2 may comprise a data processing arrangement 20, a data transmission arrangement 21, a database module 22 and/or a sensor module 23, which can serve as data sources Q for image data sets D. The data processing arrangement 20 may be equipped with data processors and memories according to the respective requirements in order to be able to process and/or to provide control signals C, image data sets D, sensor signals V and/or manipulated values W. The data transmission arrangement 21 may comprise transmitting and/or receiving modules 24 and transceivers 25 or be connected thereto via the communication infrastructure 5. The transceivers 25 can be provided, for example, as terrestrial or non-terrestrial antennas of the apparatus 1 and/or the image processing unit 2, which can be configured and arranged according to the respective requirements such that control signals C, image data sets D, sensor signals V and/or manipulated values W can be obtained and/or provided by remote data transmission.

A control program 30 with instructions for controlling the apparatus 1, the image processing unit 2, the ground station 3, the satellite 4, the communication infrastructure 5, the data center 6, the data processing system 7 and/or the display device 8 can be at least partially stored on a computer-readable data carrier 31 and can define control signals C, image data sets D, sensor signals V and/or manipulated values W described herein in addition to other data sets, parameters, markings, keys and/or method steps and can control their generation, use and/or handling. The computer-readable data carrier 31 can be present as a computer-readable medium 32 and/or data carrier signal 33. In particular, the data carrier signal 33 can be bidirectionally transmitted via light signals, cable connections and other wired and/or wireless transmission means of the communication infrastructure 5 as well as communication networks between apparatuses 1, image processing units 2, ground stations 3, satellites 4 and/or data processing systems 6 and their respective components.

FIG. 2 shows a schematic illustration of operating zones Z for operating the apparatus 1, for example a first operating zone I, a second operating zone II and/or a third operating zone III, with transitions T between them. For example, the first operating zone I can be a preparation area. The first operating zone I may be distinguished, for example, by the fact that it is outside a range of sensors and/or effectors of a mission objective M during an entire mission duration. Thus, in the first operating zone I, preparatory measures for a “hot phase” of a mission are usually carried out, such as short-term data updates, in-flight refueling, exercises and/or planning tasks. With the exception of special exemplary tasks, such as in-flight refueling, take-offs, landings and/or formation flights, in the first operating zone I, an external view provided by means of image data sets D is generally of secondary importance to the operator P and sensor signals V have a primary importance.

The second operating zone II can be a task assignment area in the present example and can be distinguished from the third operating zone III by virtue of the fact that sensors and/or effectors of a mission objective usually cannot recognize or reach the apparatus 1 or their own apparatuses 1. However, this boundary can always be in motion by a relative movement of the apparatus 1 with respect to the mission objective. Thus, the apparatus 1 is at a constant risk of entering the third operating zone III by its own maneuvers or maneuvers of the mission objective M. In the second operating zone II, distance sensors and distance effectors are usually used and further apparatuses 1, for example in the form of remote-controlled UAVs, are commissioned and/or controlled. Accordingly, in the second operating zone as well, an external view provided by means of image data sets D is generally of secondary importance to the operator P and sensor signals V have a primary importance.

In the present example, the third operating zone III contains the mission objective M. Boundaries of the third operating zone III are thus distinguished by the fact that the apparatus 1 is within range of sensors and effectors of the mission objective M. However, it is necessary to enter the third operating zone III with the apparatus 1 in order to fulfill the mission objective M. Thus, the apparatus 1 and/or operator P must face risks associated with the mission objective M, such as being detected, attacked and/or exposed to other harmful influences, such as certain environmental influences. A risk situation can always change in the third operating zone III. Immediate initiation of countermeasures may be required to avert risks. Reaching the mission objective M in the shortest possible time may need to be prioritized over any planning tasks. Accordingly, the third operating zone III may also be referred to as an action area. An external view using sensor signals V, data sets D and/or a direct outlook may be of the greatest importance to the operator P in the third operating zone III in order to reach the mission objective M unharmed.

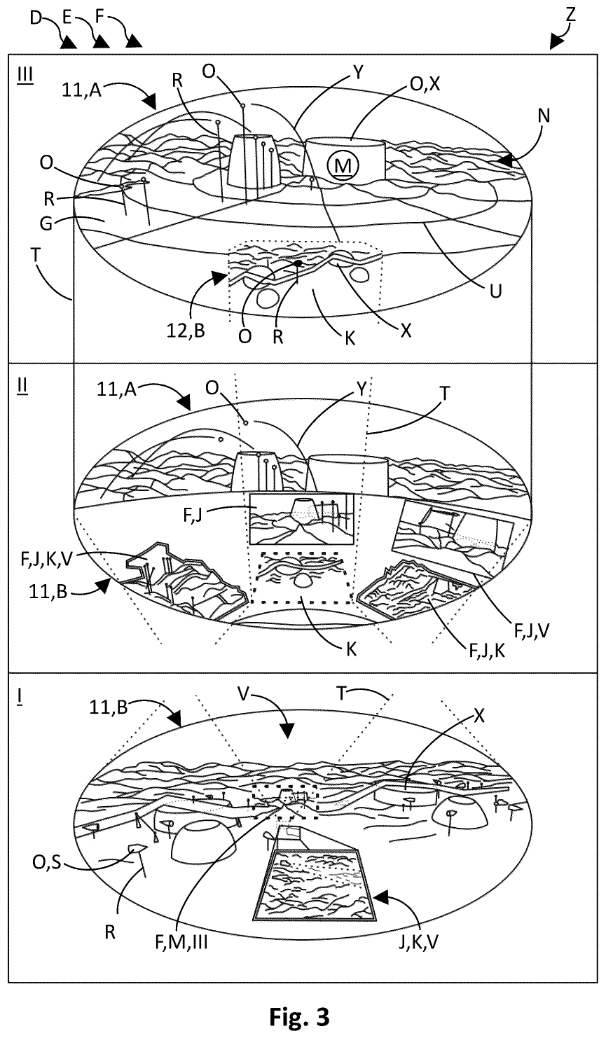

FIG. 3 shows a schematic illustration of an exemplary assignment of image data sets D to the head-mounted display device 11 and the apparatus-mounted display device 12 on the basis of the operating zones Z. The image data sets D may comprise image elements E which may each be based on a data subset F. In other words, the image data sets D and/or image elements E can be composed of data subsets F which can be obtained, processed and/or output from the image processing unit 2. The image elements E or data subsets F may comprise object groups g, subgroups h (see FIGS. 11 to 25), map data sets K, objects O, reference data sets R, symbol representations S, transitions T, perimeters U, sensor signals V, manipulated values W, hazardous areas X and/or trajectories Y, which may be combined to form egocentric image data sets A and/or exocentric image data sets B.

Thus, in a representation adapted to the third operating zone III, an egocentric image data set A can be sent to the head-mounted display device 11 and an exocentric data set B can be sent to the apparatus-mounted display device 12. By means of the egocentric image data set A, an augmented natural view N of the operator P (see FIG. 1) can be provided, for example. The natural view N can be made possible by at least partial transparency of the head-mounted display device 11.

In particular, in the egocentric image data set A, for example, objects O can be provided with reference data sets R, hazardous areas X, trajectories Y and/or perimeters or distance data sets U. For example, an object O may be referenced, on the one hand, in the natural view N relative to the ground G using the reference data sets R. On the other hand, data subsets F simultaneously contained in the egocentric image data set A and exocentric image data sets B, for example the same elements E and/or objects O, can be referenced or assigned to each other using the reference data sets R. Hazardous areas X may be arranged around objects O, such as around the mission objective M, in a similar manner to perimeters U. Such hazardous areas X can help to reproduce ranges of detectors and/or reflectors. Trajectories Y can help to reproduce past or future or expected movement paths, such as a flight path, or the like, of objects O.

The exocentric image data set B can be cut out from the egocentric image data set A or can be complementary to it, such that the apparatus-mounted display device 12 appears to the operator P to be as unaffected as possible by the head-mounted display device 11. The exocentric image data set B may comprise and/or be based on a map data set K, for example. Selected objects O can be embedded in the map data set K. Thus, the exocentric image data set B sent to the apparatus-mounted display device 11 makes it easier for the operator P to retain a general overview of his position and the events.

In a representation adapted to the second operating zone II, in the present example, both an egocentric image data set A and an exocentric image data set B can be sent to the head-mounted display device 11. For example, the egocentric image data set A can at least partially correspond to the egocentric image data set A which is sent to the head-mounted display device 11 in the third operating zone III. On the other hand, the exocentric image data set B, for example, can be superimposed on the apparatus-mounted display device 12. Thus, the exocentric image data set B according to the present example may include a multiplicity of map data sets K with different perspectives J or map sections as data subsets F, in which, depending on the requirement, sensor signals V from objects O or corresponding data subsets can be embedded. In order to make it easier for the operator P to cognitively track the transition from a representation in the third operating zone III to a representation in the second operating zone II, for example, at least one data subset F from the apparatus-mounted display device 12, for example a map data set K, can be converted in a continuous fluid movement into the exocentric data set B sent to the head-mounted display device 11.

In the first operating zone I, for example, the head-mounted display device 11 can be superimposed on the entire apparatus-mounted display device 12 by means of at least one exocentric image data set B. In the present example, this exocentric image data set B can be fully synthesized, for example, from sensor signals V and/or map data sets K. The mission objective M and/or the third operating zone III may be roughly outlined, for example, by a corresponding data subset F. Further map data sets K and/or sensor data sets V can be embedded as separate perspectives J in the exocentric image data set B. In order to make it easier for the operator P to cognitively track the transition from a representation in the second operating zone II to a representation in the first operating zone I, for example, at least one data subset F from the apparatus-mounted display device 12, here for example the marking of the third operating zone III, can again be converted in a continuous fluid movement into the exocentric data set B which is based on sensor signals V and is sent to the head-mounted display device 11.

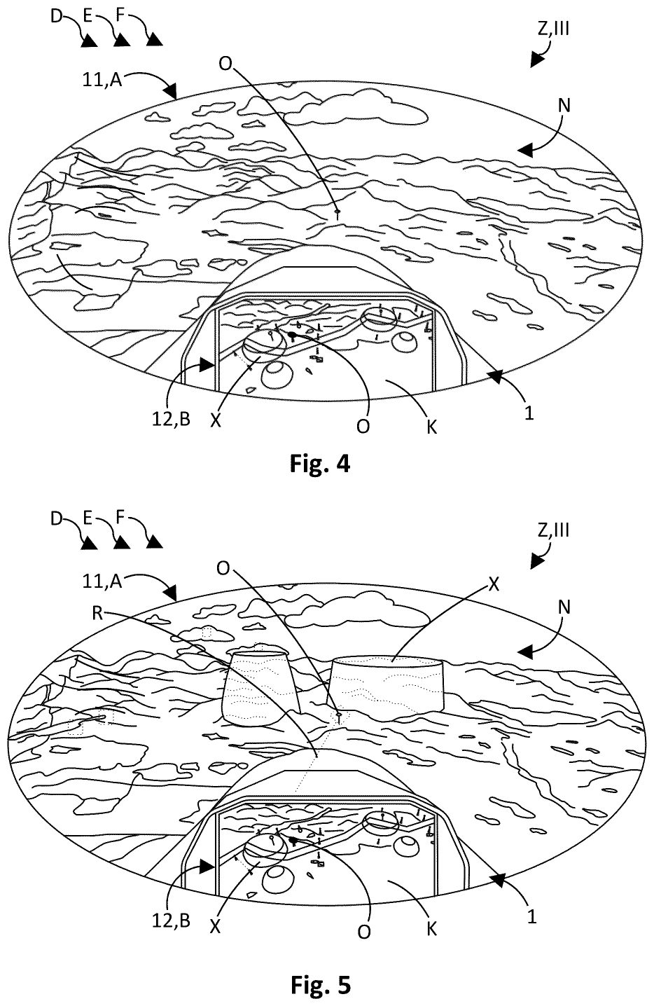

FIG. 4 shows a schematic illustration of an exemplary assignment of image data sets D to the head-mounted display device 11 and the apparatus-mounted display device 12 according to the third operating zone III. For augmenting the natural view N, for example, an object O can be embedded in it as a data subset F and for this purpose can be sent at least as part of an egocentric image data set A to the head-mounted display device 11. The exocentric image data set B sent to the apparatus-mounted display device 12 can be clearly based on a map data set, in which corresponding data subsets F of the object O and, for example, of a hazardous area X can be embedded.

FIG. 5 shows a further schematic illustration of an exemplary assignment of image data sets D to the head-mounted display device 11 and the apparatus-mounted display device 12 according to the third operating zone III. In contrast to the illustration shown in FIG. 4, in FIG. 5, for example, the hazardous area X, as a data subset F of the egocentric data set A sent to the head-mounted display device 11, is also contained as a data subset F in the exocentric data set B sent to the apparatus-mounted display device 12. A reference data set R, for example in the form of a connecting line, or the like, connects corresponding data subsets F in the egocentric data set A and exocentric data set B to each other, such that these appear to the operator P in the head-mounted display device 11 and the apparatus-mounted display device 12 at the same time in relation to each other.

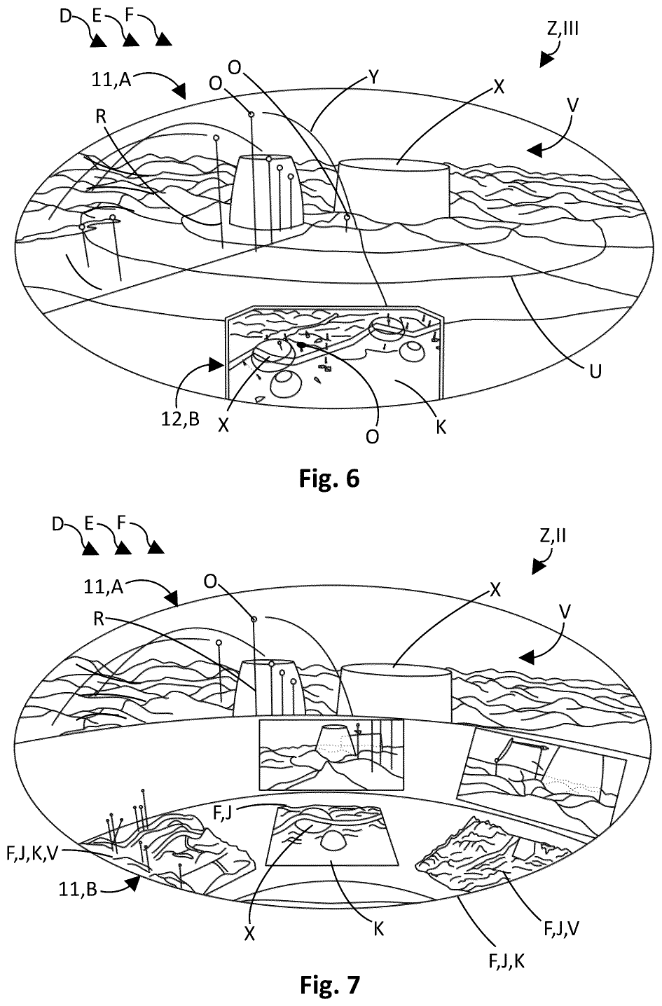

FIG. 6 shows an additional schematic illustration of an exemplary assignment of image data sets D to the head-mounted display device 11 and the apparatus-mounted display device 12 according to the third operating zone III. In contrast to the illustration shown in FIG. 5, in FIG. 6, for example, the natural view N is completely replaced by a representation based on sensor signals V. Thus, for example, an area of the apparatus 1 visible to the operator P is superimposed at least around the apparatus-mounted display device 12. In other words, the exocentric image data set B sent to the apparatus-mounted display device 12 is embedded in the egocentric image data set A sent to the head-mounted display device 11. Additional objects O and reference data sets R can be embedded in the egocentric data set A.

FIG. 7 shows a schematic illustration of an exemplary assignment of image data sets D to the head-mounted display device 11 and the apparatus-mounted display device 12 according to the second operating zone II. In contrast to the illustration shown in FIG. 6 according to the third operating zone III, an exocentric image data set B is embedded in FIG. 7, for example below the representation which is based on sensor signals V and replaces the natural view N. This exocentric image data set B can contain a number of different data subsets F, in particular map data sets K with different perspectives J, sensor signals V, etc.

FIG. 8 shows a schematic illustration of an exemplary assignment of image data sets D to the head-mounted display device 11 and the apparatus-mounted display device 12 according to the first operating zone I. In contrast to the illustration shown in FIG. 7 according to the second operating zone II, in FIG. 8, for example, the entire egocentric image data set A is replaced by an exocentric image data set B based on map data sets K and/or sensor signals V. This exocentric image data set B may include a number of different data subsets F, such as further map data sets K with other perspectives J, sensor signals V, markings of the second operating zone II and/or third operating zone III, etc. For improved orientation of the operator P, reference data sets R, such as here an artificial horizon, can be shown in such a purely synthetic exocentric image data set B as orientation aids.

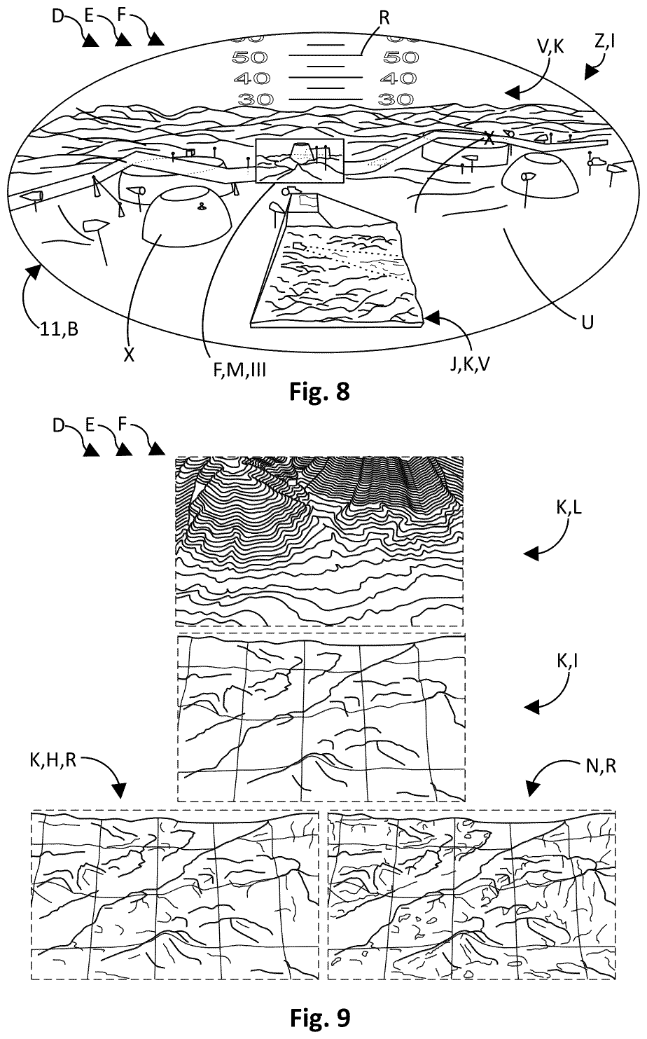

FIG. 9 shows a schematic illustration of an image data set D with image elements E in a plurality of levels of detail. For example, data subsets F can be based on map data sets K with different levels of detail. Here, a map data set K is shown accordingly in a high level of detail H, a medium level of detail I and a low level of detail L, which is based on a corresponding natural view N of a terrain section that may be provided with a reference data set R in the form of a grid. The high level of detail H can reproduce details of the natural view N that are contained, for example, in the image data set D as accurately as possible. In the medium level of detail I, for example, the image data set D can be reduced to a roughly realistic representation of the terrain. The low level of detail L can reduce the terrain to reliefs, for example.

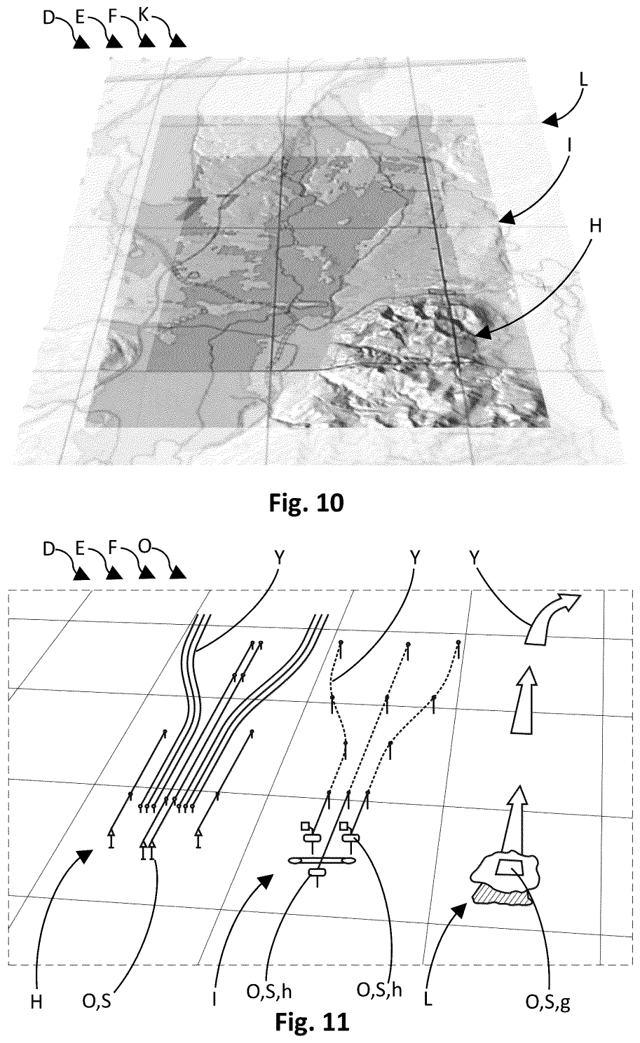

FIG. 10 shows a schematic illustration of an image data set D with image elements E in a plurality of overlaid levels of detail. For example, the image data set D here contains data subsets F based on a map data set K. The image elements E of this map data set K are contained in the high level of detail H, the medium level of detail I and the low level of detail L of simultaneously overlaid image data sets D.

FIG. 11 shows a schematic illustration of an image data set D with data subsets F in a plurality of levels of detail. Symbol representations S of objects O as well as their trajectories Y are shown here in the high level of detail H, the medium level of detail I and the low level of detail L. In the high level of detail H, the objects O and their trajectory Y can all be contained individually in the image data set D, partially in the form of corresponding data subsets F, which can each represent an image element E. In the medium level of detail I, a certain number of objects can be combined in subgroups h, which then each have corresponding trajectories Y. In the low level of detail L, all subgroups h can be combined to form a group g which has a corresponding trajectory Y.

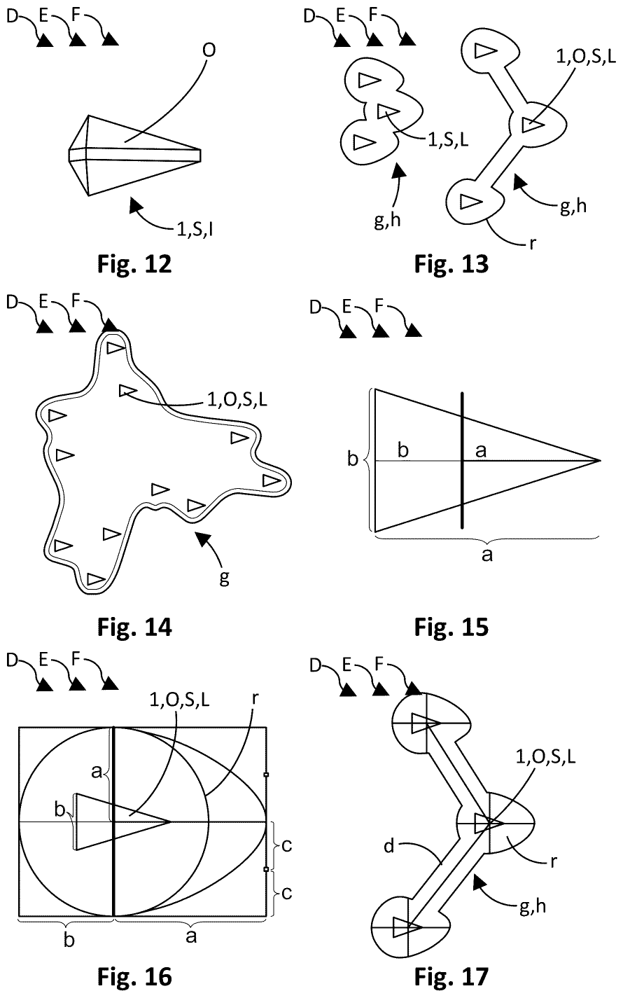

FIG. 12 shows a schematic symbol representation S of an object O. For example, the object O can be the apparatus 1 in the form of an aircraft. The symbol representation S of the apparatus 1 abstracts it to such an extent that, for example, its nose and tail are represented with certain three-dimensional hints.

FIG. 13 shows a schematic symbol representation of object groups g. For example, the object groups g can be included as a multiplicity of subgroups h in an image data set D. The two subgroups h shown can each represent, for example, a data subset F of the image data set D. The objects O, for example in the lowest level of detail L, may be contained in the subgroups h, where, in the case of the apparatus 1 in the form of an aircraft, which is used here, for example, as an object O, at most its nose and tail are recognizable in a two-dimensional representation. In the subgroups h, the objects O can be provided with individual object radii r.

FIG. 14 shows a further schematic symbol representation S of a single object group g. A multiplicity of objects O, for example in the lowest level of detail L, are contained in this object group g. An assignment of the objects to subgroups h is not provided. Individual object radii r are not present.

FIG. 15 shows a further symbol representation S of an object O. The symbol representation S of the object O can be constructed with a symbol length a and a symbol width b. The symbol width b can be less than the symbol length a so as to be able to provide a triangular or arrowhead-like representation.

FIG. 16 shows a schematic symbol representation of an object for an object group g and/or subgroup h. Thus, for example, the symbol radius r can correspond to the symbol length a and can be placed around a symbol center. The symbol radius r can be expanded toward the symbol tip, for example by corresponding to the symbol length a from the symbol tip, wherein partial lengths c can also be used to construct the symbol radii r, which partial lengths can be based, for example, on predefined fractions of the symbol length a, the symbol width b and/or the radius r.

FIG. 17 shows a schematic symbol representation of an object group with symbol representations S of objects O that are shown in FIG. 16. Here, the objects O are combined in an object group g or subgroup h. For example, for the combined representation of the objects O, their project radii r can be represented in a manner bridged by symbol distances d.

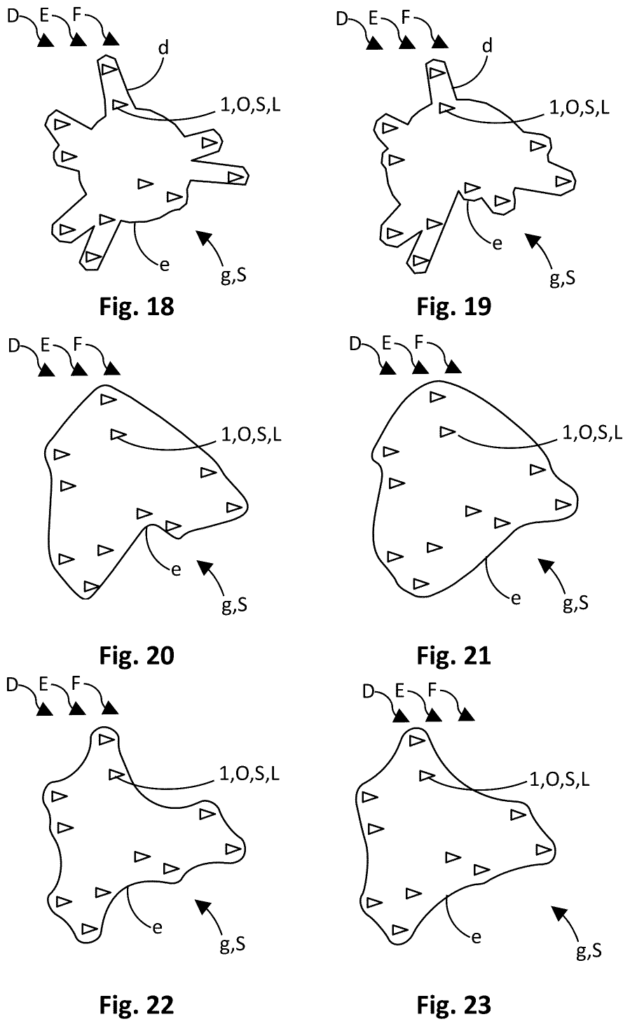

FIG. 18 shows a schematic symbol representation S of an object group g. The entire object group g is represented in a manner combined by an envelope e. The envelope e can be formed by means of intersection lines between the objects O and can also represent symbol distances in the area of the objects O that are exposed.

FIG. 19 shows a further schematic symbol representation S of the object group g shown in FIG. 18. In contrast to the illustration shown in FIG. 18, the envelope e is closer to the central object O. On the other hand, symbol distances d are shortened for external objects O.

FIG. 20 shows an additional schematic symbol representation of the object group g shown in FIGS. 18 to 19. Here, the envelope e is formed, for example, by means of an algorithm using a basis spline. Thus, no object distances d are represented.

FIG. 21 shows an alternative schematic symbol representation S of the object group g shown in FIGS. 18 to 20. Here too, the envelope e is formed, for example, by means of an algorithm using a basis spline. Thus, once again, no object distances d are represented.

FIG. 22 shows a further alternative schematic symbol representation S of the object group g shown in FIGS. 18 to 21. Here, the envelope e is formed, for example, by means of an algorithm using Connolly surfaces. No object distances d are represented.

FIG. 23 shows an additional alternative schematic symbol representation of the object group shown in FIGS. 18 to 22. Here too, the envelope e is formed, for example, by means of an algorithm using Connolly surfaces. Once again, no object distances d are represented.

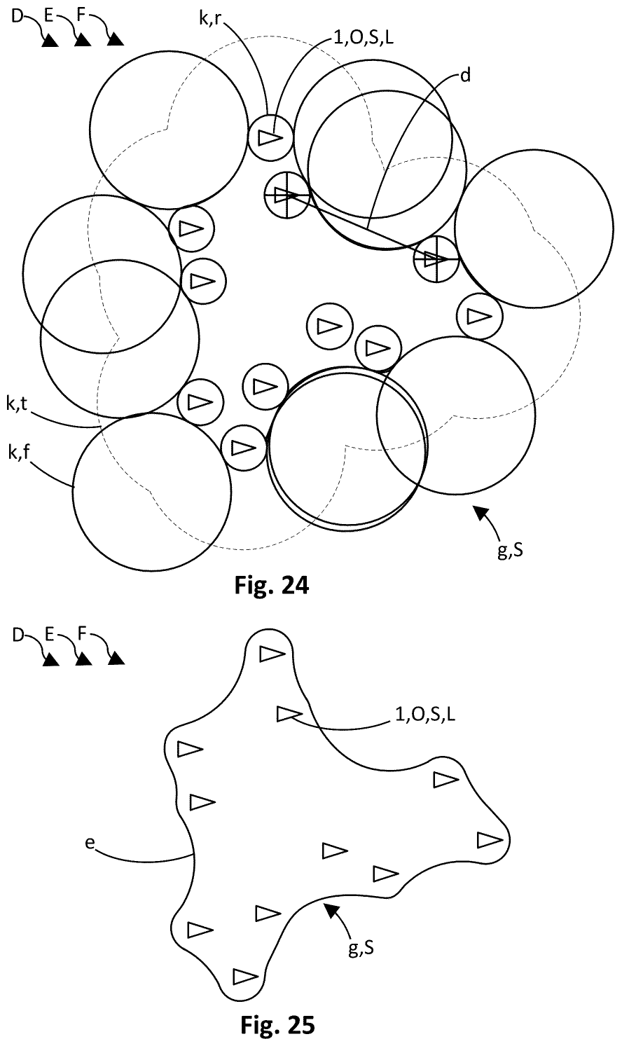

FIG. 24 shows a schematic representation of construction elements k for generating a symbol representation S of the object group g shown in FIGS. 18 to 23. Construction elements k can comprise, for example, the symbol radius r of the individual objects O, a sensor f and/or a trajectory t. Thus, the object group g with the sensor f, which can have a corresponding radius, can be traversed externally along the radii r of the objects, where, for example, a center of the sensor can draw the trajectory t.

FIG. 25 shows a schematic symbol representation of the object group shown in FIGS. 18 to 23 after using the construction elements k shown in FIG. 24. The data subset F, which is formed as an image element E by the envelope e, can be calculated with the aid of the trajectory t of the sensor f. This makes it possible to provide an algorithm that uses Connolly surfaces to form the symbol representation S of the group g.

List of reference signs

| | |
|---|---|
| 1 | Apparatus/aircraft |
| 2 | Image processing unit |
| 3 | Ground station |
| 4 | Satellite |
| 5 | Communication infrastructure |
| 6 | Data center |
| 7 | Data processing system |
| 8 | Display device |
| 10 | Operating arrangement |
| 11 | Head-mounted display device |
| 12 | Apparatus-mounted display device |
| 13 | Sensor element |
| 14 | Actuator |
| 15 | Apparatus structure |
| 20 | Data processing arrangement |
| 21 | Data transmission arrangement |
| 22 | Database module |
| 23 | Sensor module |
| 24 | Transmitting and/or receiving |
| | module |
| 25 | Transceiver |
| 30 | Control program |
| 31 | Computer-readable data carrier |
| 32 | Computer-readable medium |
| 33 | Data carrier signal |
| I | First operating zone |
| II | Second operating zone |
| III | Third operating zone |
| a | Symbol length |
| b | Symbol width |
| c | Partial length |
| d | Symbol distance |
| e | Envelope |
| f | Sensor |
| g | Object group/grouping data set |
| h | Subgroup |
| k | Construction element |
| r | Symbol radius |
| t | Trajectory |
| A | Egocentric image data set |
| B | Exocentric image data set |
| C | Control signal |
| D | Image data set |
| E | Image element |
| F | Data subset |
| G | Ground |
| H | High level of detail |
| I | Medium level of detail |
| J | Perspective |
| K | Map data set |
| L | Low level of detail |
| M | Mission objective |
| N | Natural view |
| O | Object |
| P | Operator |
| Q | Data source |
| R | Reference data set/referencing |
| | means |
| S | Symbol representation |
| T | Transition |
| U | Perimeter/distance |
| V | Sensor signal |
| W | Manipulated value |
| X | Hazardous area |
| Y | Trajectory |
| Z | Operating zone |

1. A method for providing an image data set from an image processing unit of an apparatus, to at least one display device for an operator of the apparatus,
wherein the image data set comprises at least two levels of detail of at least one image element obtained from at least one of a sensor module, a database module or a receiving module.

2. The method as claimed in claim 1, wherein the at least one image element is part of a data subset obtained from at least one of a data memory, the sensor module or by remote data transmission.

3. The method as claimed in claim 2, wherein the at least one image element in at least one of the at least two levels of detail is abstracted to form a symbol representation.

4. The method as claimed in claim 3, wherein at least one of the at least two levels of detail is at least partially superimposed on at least one other of the at least two levels of detail.

5. The method as claimed in claim 1, wherein the at least two levels of detail are incremented in a predefined manner.

6. The method as claimed in claim 1, wherein at least one of objects, object groups or routes or trajectories of the objects or object groups captured by the sensor module are provided in at least one of the at least two levels of detail as a single or combined image element.

7. (canceled)

8. A non-transitory computer-readable data carrier on which a control program is stored, the computer program comprising instructions which, when the control program is executed by an image processing unit, cause the image processing unit to carry out the method according to claim 1.

9. An image processing unit for an apparatus, wherein the image processing unit is configured to carry out the method as claimed in claim 1.

10. An apparatus comprising an image processing unit as claimed in claim 9.

11. The apparatus according to claim 10, wherein the apparatus is an aircraft.
